(19) United States
(12) Patent Application Publication
(10) Pub. No.: US 2004/0197237 A1
(43) Pub. Date: Oct. 7, 2004

(54) Apparatus for displaying self monitoring blood glucose equipment and supplies

(76) Inventor: Michael Piro, Huntersville, NC (US)

Correspondence Address: PHILIP S. JOHNSON, JOHNSON & JOHNSON, ONE JOHNSON & JOHNSON PLAZA, NEW BRUNSWICK, NJ, 08933-7003, US

(21) Appl. No.: 10/777,865

(22) Filed: Feb. 11, 2004

Related U.S. Application Data
(60) Provisional application No. 60/446,508, filed on Feb. 11, 2003.

(51) Int. Cl. B01L 9/00

(52) U.S. Cl. 422/104

(57) ABSTRACT

The present invention is directed to various embodiments of an apparatus for displaying self monitoring blood glucose equipment and supplies, while providing a deterrent to theft. In various embodiments, the apparatus may comprise system trays, strip trays, support pillars, push plates, tension coils, signboards, and theft deterrent covers. The apparatus is modular in nature, and provides coordinated display of equipment and supplies.

### BACKGROUND OF THE INVENTION

This application claims priority to Provisional Application Serial No. 60/446,508 filed Feb. 11, 2003, which is incorporated herein by reference in its entirety and to which we claim priority.

A variety of medical diagnostic procedures involve tests on biological fluids, such as blood, urine, or saliva, to determine an analyte concentration in the fluid. Among the analytes of greatest interest is glucose, and dry phase reagent strips incorporating enzyme-based compositions are used extensively in clinical laboratories, physicians, offices, hospitals, and homes to test samples of biological fluids for glucose concentration. In fact, reagent strips have become an everyday necessity for many of the nation's estimated 16 million people with diabetes. Since diabetes can cause dangerous anomalies in blood chemistry, it can contribute to vision loss, kidney failure, and other serious medical consequences. To minimize the risk of these consequences, most people with diabetes must test themselves periodically, then adjust their glucose concentration accordingly, for instance, through diet control and/or with insulin injections. Some patients must test their blood glucose concentration as often as four times or more daily.

It is especially important for people with diabetes who must control their diet in order to regulate sugar intake and/or administer insulin injections, and who must be guided in this regard by frequent tests of blood glucose concentration, to have a rapid, inexpensive, and accurate system for glucose determination.

Systems for monitoring blood glucose concentrations are available from several manufacturers. Systems typically include meters, test strips, control solutions, and lancing devices. Components such as test strips, control solutions, and lancing devices are consumables, and must be purchased by the consumer on a regular basis. Consumables designed for one system are not typically compatible with those designed for another system, so it is important that the consumer purchase the correct consumables for their particular system. With the myriad of systems on the market today, this can be a daunting task.

For retailers of blood glucose monitoring equipment, theft of consumables can be a costly problem. A small box of test strips can be easily concealed, and can cost tens of dollars, making them a desirable target for thieves.

For security reasons, many retailers stock blood glucose monitoring equipment in locked cabinets, accessible only to pharmacy personnel. This limits the consumer's ability to compare products, and forces them to get in line for the pharmacy worker's attention. This is undesirable for the consumer.

It would therefore be desirable to provide an apparatus that allowed retailers to stock blood glucose monitoring equipment on shelves accessible to the consumer, without requiring the assistance of pharmacy personnel. Such an apparatus would need to coordinate consumable with non-consumable components, allowing consumers to purchase the correct consumables for their systems. It would also be desirable for the apparatus to discourage theft by limiting access to large quantities of the most expensive and concealable components.

Information relevant to attempts to address these problems can be found in the following patents. However, none of the references provide the means to coordinate consumable and non-consumable components while providing a deterrent to theft.

U.S. Pat. No. 4,901,869 to Hawkinson et al. describes a merchandise display rack comprising a series of chutes that may be connected side by side or stacked. Each chute has a central slideway with a push plate slide, which is pulled forward by an elongated spring. Horizontal, lateral extension panels having parallel back to back V-grooves across the width thereof may readily be broken off along straight lines to selected widths and interlocked to the sides of the slideway. A longitudinal connector member interlocks with the lateral extension panels and vertical side panels to form the chute.

U.S. Pat. No. 5,111,942 to Bernardin describes a channel that is adapted to receive partly nested objects in a queue. A clamp/pusher member associated with a return spring urges product towards an anterior abutment wall, and is associated with a slide member sliding in a central guide corridor, while a return spring forms at least one outward run in each of the two side passages between at least one direction-changer pulley wheel and an anchor point. A plurality of merchandisers may be mounted on a strip member for the purposes of aligning the merchandisers with the shelving and securing them to it.

U.S. Pat. No. 5,665,304 to Heinen et al. describes a rack unit display system that displays goods, such as in a retail store, in a well structured and ordered manner. The goods are horizontally stacked in the rack unit. A theft protection member is provided which limits unauthorized access to the goods. The left protection member is adjustable in height to allow the display unit to accommodate different sized goods. The goods are pushed forward in the unit by a slide member where the units can then be removed from the rack in small quantities. The back unit is releasably mounted and secured by a lock mechanism on a base member, which in turn is mounted on a rectangular bar. The rack unit can be released from the base member by means of a key. The slide member can be locked in a rear end position of the display unit when the rack unit is removed from the base member. The unit can be filled or refilled with ease without interference from the slide member. The height of the theft protection member is also adjustable.

When the rack unit is mounted on the base member, the slide member is automatically released, thereby pushing goods forward.

U.S. Pat. No. 5,806,690 to Johnson et al. describes a display apparatus that includes a length adjustable track upon which a spring biased movable plate travels. A friction lock is provided to secure the track at selected lengths and is incorporated into stacking supports for interconnecting an array of display units.

U.S. Pat. No. 5,855,281 to Rabas describes a product display system that includes a basic unit including a track, a front wall, a back wall and a side member. The basic unit is easily assembled and disassembled. Two of more basic units can be ganged together to created customized displays to accommodate a wide varies of products of various sizes.

U.S. Pat. No. 6,409,027 to Chang et al. describes an apparatus for displaying and dispensing flat objects of different widths from a tray that includes an open top tray having a bottom wall, opposed side walls, a front wall and a back wall. A pair of elongated panels are slidably mounted in the bottom wall of the tray so that they can move along independent paths of travel from the back wall toward the front wall.

Wound spring motors urge the panels toward the front wall of the tray so that flat articles of a first width stacked in the tray between one panel and the front wall will be supported in an upright position and the panel will automatically move forward when one of the articles is removed from the tray. The panel can be held in a coplanar side by side relationship by removable connectors whereby articles of greater width can be stacked in the tray.

U.S. Pat. No. 6,409,028 to Nickerson describes a self-facing, add-on shelf system made up of a universal base, divider, front, and rear sections. The base is universal in the sense that the sections form basic building sections for constructing shelf systems of various sizes and operational mode. The front and rear track sections are identical and can be combined with various combinations of bases, dividers and end sections to provide systems of different, desired widths. The depth of the self-facing shelf is generally set by the depth of the shelf with which it is to be used. The individual sections can be selected and combined to provide center pusher, side pusher, and gravity feed types of self facing systems. The bases, dividers and end sections are configured such that they can be extruded and interlock in assembly.

None of the systems described above provide an apparatus that allows retailers to stock blood glucose monitoring equipment on shelves accessible to the consumer, without requiring the assistance of pharmacy personnel. They do not coordinate consumable with non consumable components and do not discourage theft by limiting access to large quantities of the most expensive and concealable components.

### SUMMARY

The present invention is directed to an apparatus for displaying self monitoring blood glucose equipment and supplies while providing a deterrent to theft. The apparatus comprises a system tray, a lower strip tray, a pillar, and an upper strip tray. The system tray has a proximal wall, a distal wall, a first sidewall, a second sidewall, and a base. The lower strip tray has a proximal wall, a distal wall, a first sidewall, a second sidewall, and a base. The lower strip tray is connected at the first sidewall to the second sidewall of the system tray. The pillar has a lower end and an upper end, and is vertically connected at the lower end to the distal wall of said lower strip tray. The upper strip tray has a proximal wall, a distal wall, a first sidewall, a second sidewall, and a base. The upper strip tray is connected to the upper end of the pillar.

In another embodiment, the apparatus further comprises a system tray push plate, a system tray tension coil, a lower strip tray push plate, a lower strip tray tension coil, an upper strip tray push plate, and an upper strip tray tension coil. The system tray push plate is moveably connected to the base of the system tray. The system tray tension coil is positioned between the system tray base and the system tray push plate. The lower strip tray push plate is moveably connected to the base of the lower strip tray. The lower strip tray tension coil is positioned between the lower strip tray base and the lower strip tray push plate. The upper strip tray push plate is moveably connected to the base of the upper strip tray. The upper strip tray tension coil is positioned between the upper strip tray base and the upper strip tray push plate.

In another embodiment, the apparatus further comprises a system tray signboard, a lower strip tray signboard, and an upper strip tray signboard. The system tray signboard is attached to the proximal wall of the system tray. The lower strip tray signboard is attached to the proximal wall of the lower strip tray. The upper strip tray signboard is attached to the proximal wall of the upper strip tray.

In another embodiment, the apparatus further comprises a strip theft deterrent cover.

The strip theft deterrent cover is vertically positioned adjacent to the second sidewall of the lower strip tray.

In another embodiment, the apparatus further comprises a system theft deterrent cover, and an upper theft deterrent cover. The system theft deterrent cover has an upper end and a lower end, and is vertically positioned adjacent to the first sidewall of the system tray. The upper theft deterrent cover has a first end and a second end, and is connected at the first end to the upper end of the system theft deterrent cover, and at the second end to the upper end of the strip theft deterrent cover.

### BRIEF DESCRIPTION OF THE DRAWINGS

These and other features, aspects, and advantages of the present invention will become better understood with regard to the following description, appended claims, and accompanying drawings where:

FIG. 1 illustrates a self monitoring blood glucose meter and its associated test strips;

FIG. 2 illustrates the contents of a self monitoring blood glucose system kit, and the contents of a box of self monitoring blood glucose test strips;

FIG. 3 illustrates a locked display case containing self monitoring blood glucose equipment and supplies, such as that which is currently used by retailers;

FIG. 4 illustrates a consumer being assisted by a pharmacy employee in purchasing self monitoring blood glucose equipment and supplies;

FIG. 5 illustrates a consumer with direct access to a wide variety of self monitoring blood glucose equipment and supplies;

FIG. 6 illustrates a thief stealing self monitoring blood glucose supplies from an unprotected retail shelf;

FIG. 7 illustrates a consumer with direct access to a well organized, coordinated embodiment of an apparatus for displaying self monitoring blood glucose equipment and supplies;

FIG. 8 illustrates a thief impeded by an embodiment of an apparatus for displaying self monitoring blood glucose equipment and supplies;

FIG. 9 illustrates a single row of self monitoring blood glucose systems grouped with 2 rows of matching self monitoring blood glucose test strips; in addition, FIG. 9 illustrates three different rows of self monitoring blood glucose systems grouped with 2 rows of matching self monitoring blood glucose test strips;

FIG. 10 illustrates a close up view of three different rows of self monitoring blood glucose systems grouped with 2 rows of matching self monitoring blood glucose test strips;

FIG. 11 illustrates a perspective view of an embodiment of an apparatus for displaying self monitoring blood glucose equipment and supplies;

FIG. 12 illustrates an exploded perspective view of an embodiment of an apparatus for displaying self monitoring blood glucose equipment and supplies;

FIG. 13 illustrates a perspective view showing the interlocking tenons of an embodiment of an apparatus for displaying self monitoring blood glucose equipment and supplies;

FIG. 14A illustrates an embodiment of an apparatus for displaying self monitoring blood glucose equipment and supplies with a strip theft deterrent cover;

FIG. 14B illustrates an embodiment of an apparatus for displaying self monitoring blood glucose equipment and supplies with a strip theft deterrent cover, a system theft deterrent cover, and an upper theft deterrent cover;

FIG. 15 illustrates an embodiment of an apparatus for displaying self monitoring blood glucose equipment and supplies with coordinated signboards that assist in matching blood glucose monitoring test strips to the appropriate system.

### DESCRIPTION

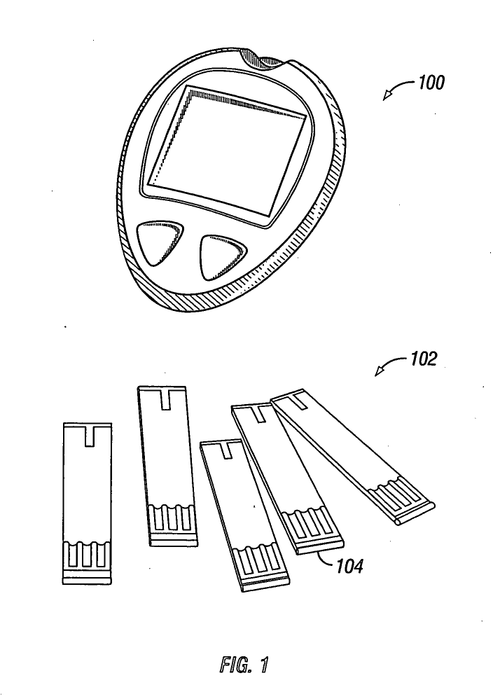

FIG. 1 illustrates a self monitoring blood glucose meter 100 and it's associated test strips 102. Meter 100 is typically a handheld, battery-operated instrument. The user typically inserts a single test strip 104 into the meter 100, lances their finger, and applies a drop of blood to the test strip 104. Within seconds, the meter 100 reports a blood glucose value to the user. The meter 100 uses disposable test strips 102 that are specially designed for use in the meter 100. Test strips 102 are designed for use in its matching meter 100, and typically can't be used in non-matching meters.

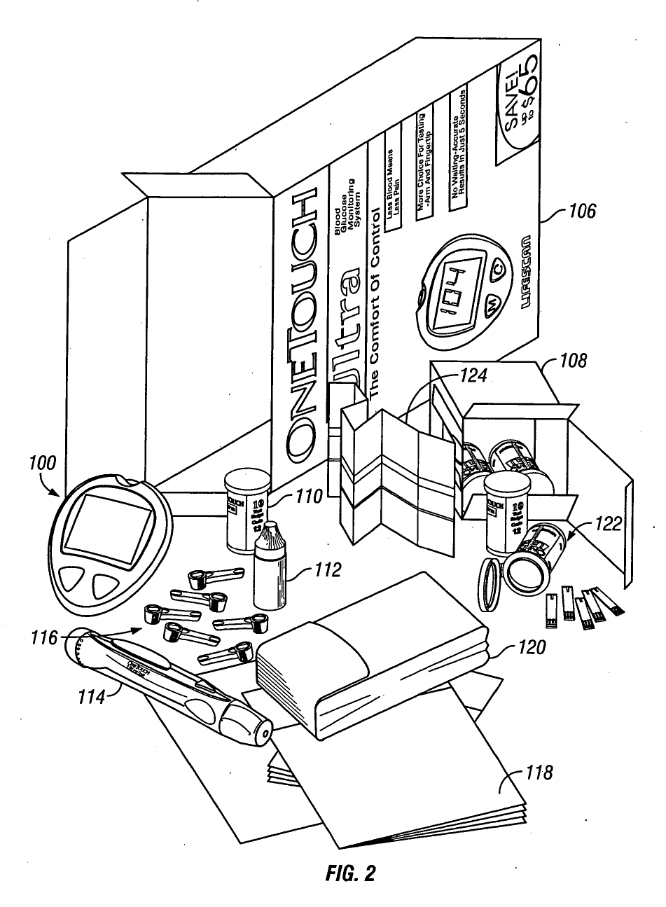

FIG. 2 illustrates the contents of a self monitoring blood glucose system kit 106, and the contents of a box of self monitoring blood glucose test strips 108. The system kit 106 contains a meter 100, a vial of test strips 110, a vial of control solution 112, a lancing device 114, disposable lancets 116, documentation 118, and a tote 120. The box of test strips 108 typically includes vials of test strips 122 and a package insert 124. As can be seen by the contents of the system kit 106 and the box of test strips 108, there are a variety of components required to perform self monitoring blood glucose tests. Matching the appropriate consumable components with meters can be a daunting task for consumers.

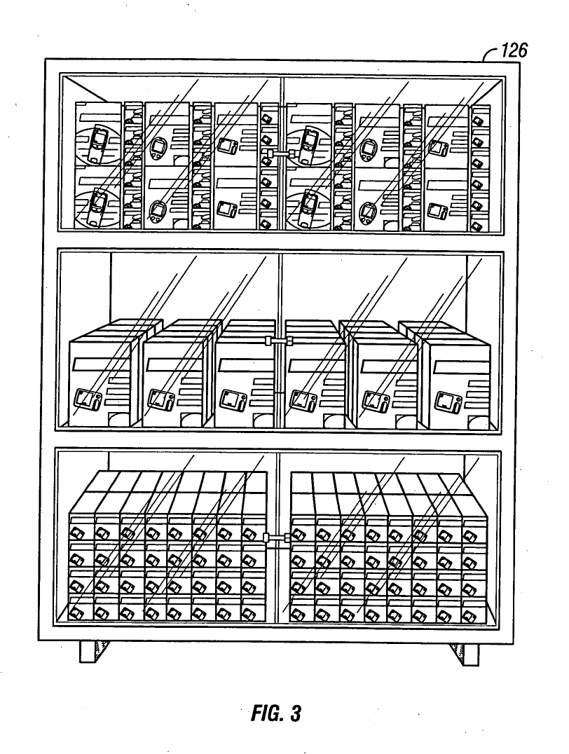

FIG. 3 illustrates a locked display case 126, such as those typically used by retailers of self monitoring blood glucose equipment and supplies. The display case 126 contains a wide variety of self monitoring blood glucose equipment and supplies offered by several manufacturers. Supplies include test strips, control solution, lancing devices, and disposable lancets. Often times, retailers place supplies wherever they fit in the case, without regard to coordination of supplies with their matching systems. Matching supplies with the appropriate meters can, once again, be a daunting task.

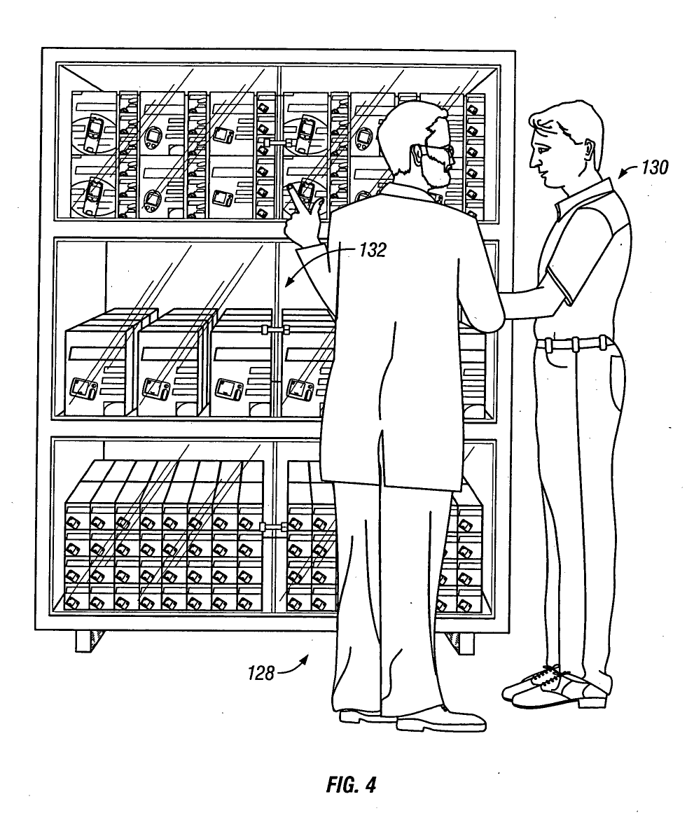

FIG. 4 illustrates a pharmacy worker 128 assisting a consumer 130 in selection of self monitoring blood glucose equipment and supplies 132. The consumer 130 must often wait in line before the pharmacy worker 128 is available to help. Although inconvenient to the consumer, this approach allows the worker 128 to assist in the selection of the appropriate supplies and systems, and prevents theft. For these reasons, it is common for retailers to stock self monitoring blood glucose equipment and supplies in this fashion.

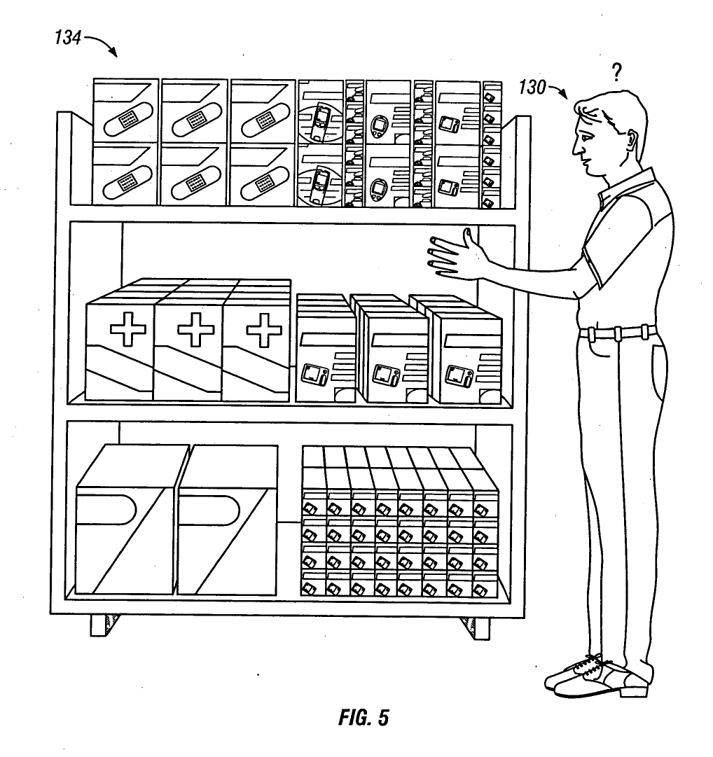

FIG. 5 illustrates a consumer 130 with direct access to an open shelf 134containing a variety of self monitoring blood glucose equipment and supplies. Although this approach eliminates the need to wait for the assistance of a pharmacy worker, it leaves the consumer with the daunting task of matching supplies to a specific system.

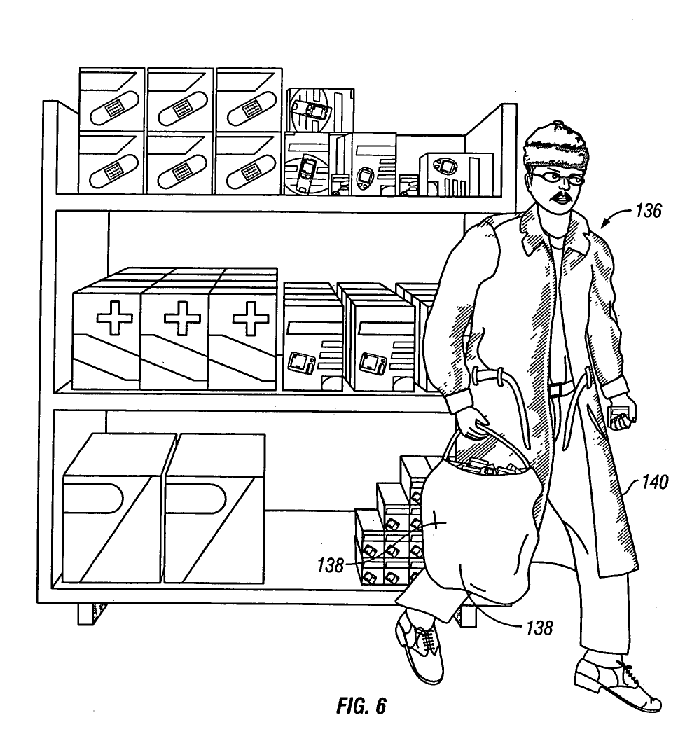

FIG. 6 illustrates a thief 136 stealing product from a retail shelf where products are stocked without an apparatus for displaying self monitoring blood glucose equipment and supplies. A thief 136 can easily conceal thousands of dollars worth of self monitoring blood glucose equipment and supplies. This is one reason why retailers keep their product behind locked display cases. An entire row of test strips can be placed into a shopping bag 138, or the pocket of a loose fitting coat 140.

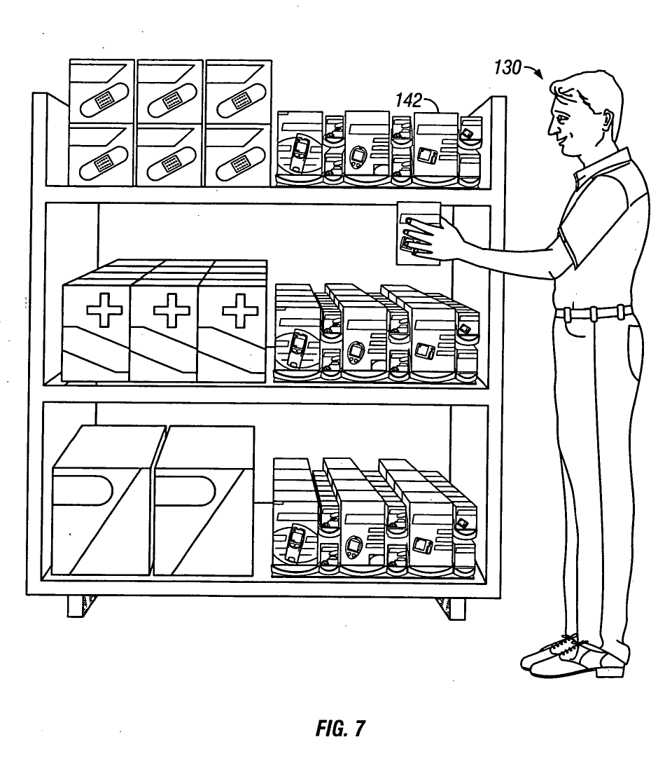

FIG. 7 illustrates a consumer 130 with direct access to a well organized, coordinated apparatus for displaying self monitoring blood glucose equipment and supplies 142. The apparatus for displaying self monitoring blood glucose equipment and supplies 142 stores systems and their matching test strips in close proximity, making the task of matching the appropriate systems and test strips less intimidating. If the consumer 130 has already purchased a system, and is simply purchasing additional test strips, the graphics on the system package can act as a guide in helping the consumer 130 select the appropriate test strips.

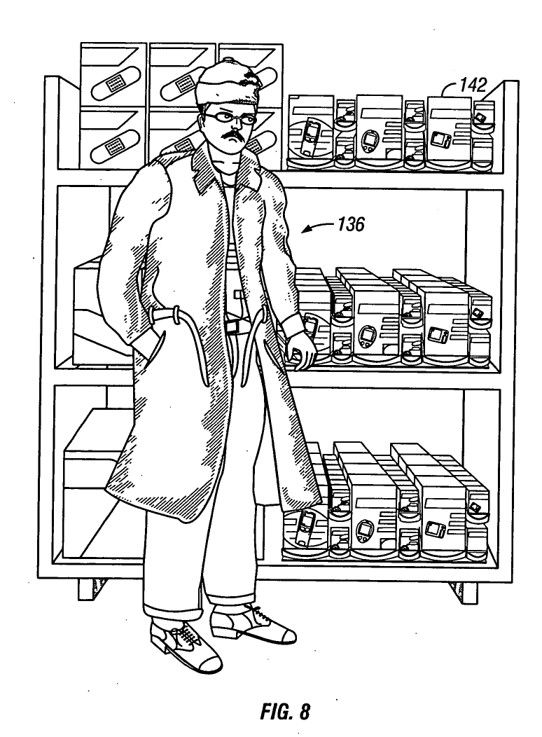

FIG. 8 illustrates a thief 136 that has been that has been prevented from stealing self monitoring blood glucose supplies. The confined, and closely spaced apparatus for displaying self monitoring blood glucose equipment and supplies 142 make it difficult to discreetly remove a row of test strips from a shelf. This impedes the thief 136, and makes his actions more conspicuous.

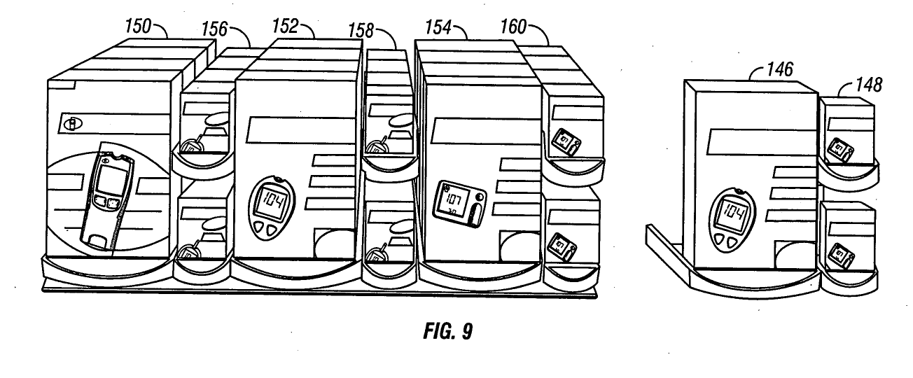

FIG. 9 illustrates a single row of self monitoring blood glucose systems 146 grouped with 2 rows of matching self monitoring blood glucose test strips 148. FIG. 9 also illustrates three rows of different self monitoring blood glucose systems 150, 152, and 154 grouped with their respective test strips 156, 158, and 160. This illustrates how various systems can be displayed with an embodiment of an apparatus for displaying self monitoring blood glucose equipment and supplies. A family of systems can be displayed with their corresponding test strips in a way that makes selection of supplies straightforward. If a retailer moves product from behind locked cabinets onto open shelves, thus making it more accessible to the consumer, the coordination of systems and their supplies becomes more and more important.

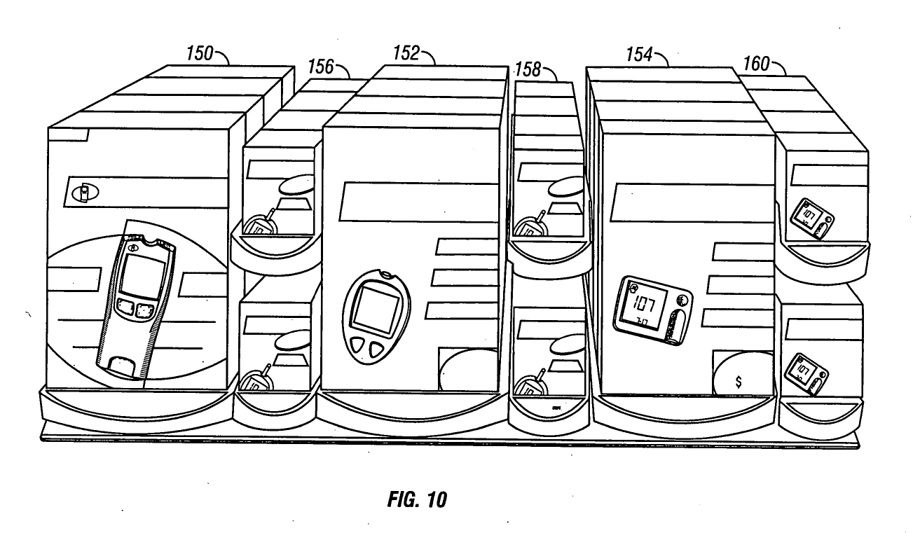

FIG. 10 illustrates an enlarged view of an embodiment of an apparatus for displaying self monitoring blood glucose equipment and supplies. Three rows of different systems 150, 152, and 154 are grouped with their respective test strips 156, 158, and 160. A single manufacturers family of meters and test strips can be displayed in this way. As a consumer removes product from any of the rows, additional product is automatically pushed to the front of the display. Graphics on the systems 150, 152, and 154 match those found on the corresponding test strips 156, 158, and 160. The mechanism that feeds product to the front of the display, along with the tight spacing in which the product is displayed, make it difficult for a thief to discreetly remove an entire row of test strips 156, 158, and 160.

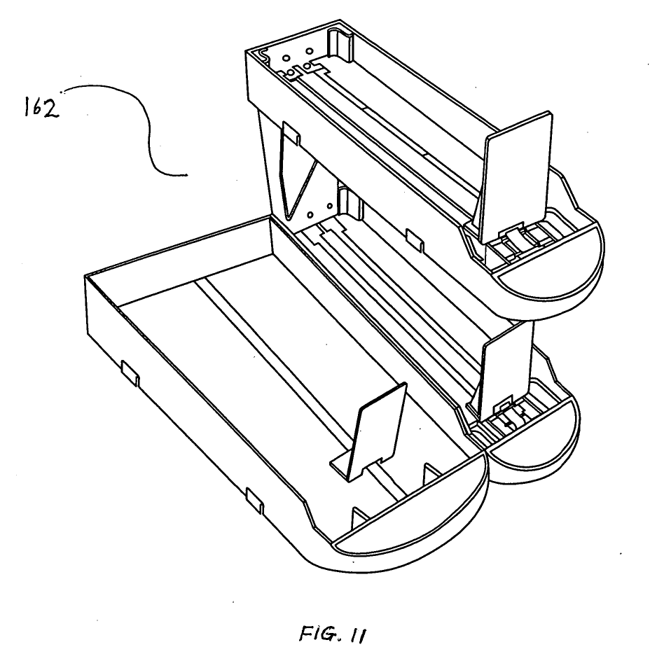

FIG. 11 illustrates a perspective view of an embodiment of an apparatus for displaying self monitoring blood glucose equipment and supplies 162.

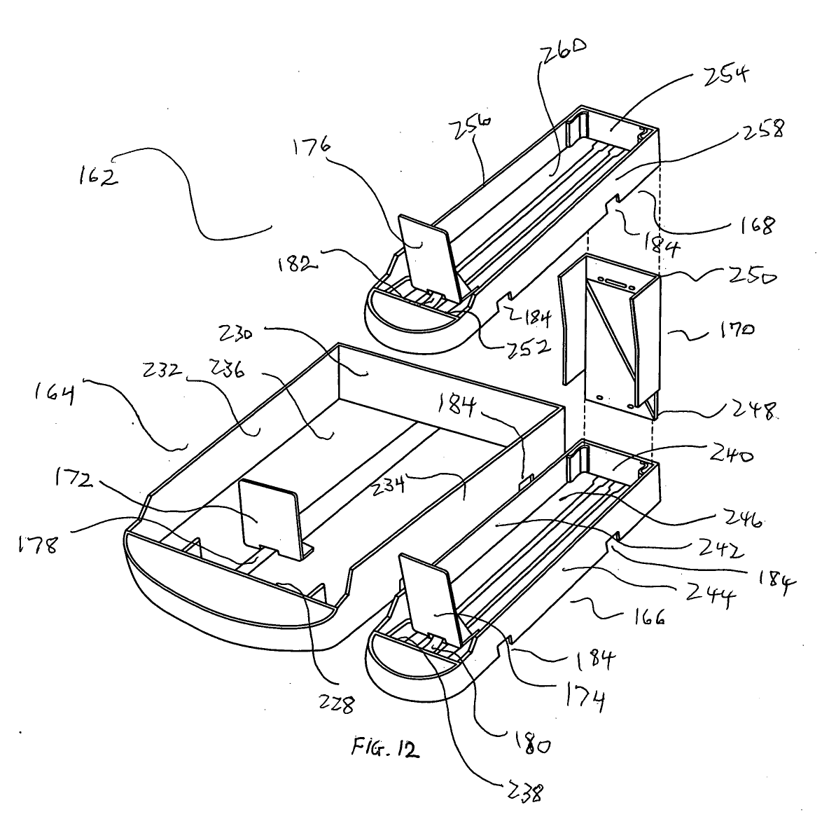

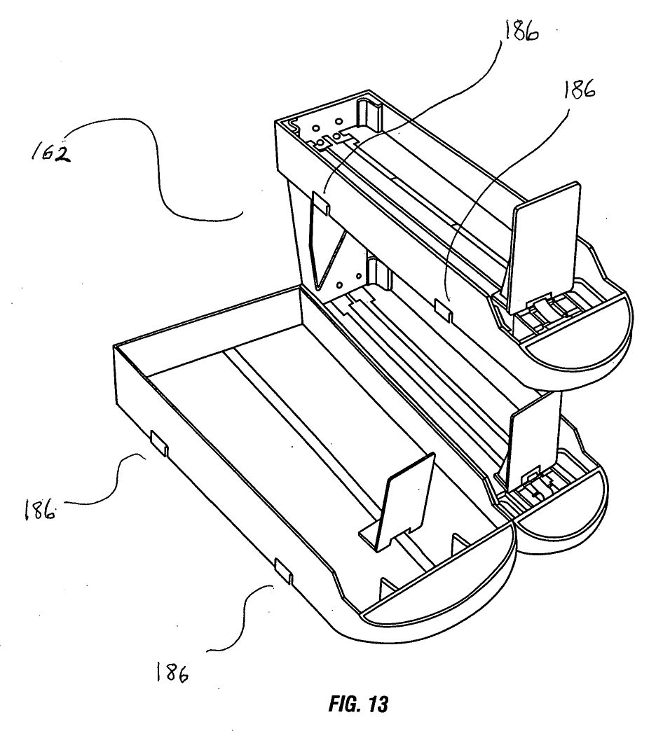

FIG. 12 illustrates an exploded perspective view of an embodiment of an apparatus for displaying self monitoring blood glucose equipment and supplies 162. The apparatus displayed in this figure comprises a system tray 164, a lower strip tray 166, a pillar 170, and an upper strip tray 168. The apparatus further comprises a system tray push plate 172, a system tray tension coil 178, a lower strip tray push plate 174, a lower strip tray tension coil 180, an upper strip tray push plate 176, and an upper strip tray tension coil 182. The system tray 164 has a proximal wall 228, a distal wall 230, a first sidewall 232, a second sidewall 234, and a base 236. The lower strip tray 166 has a proximal wall 238, a distal wall 240, a first sidewall 242, a second sidewall 244, and a base 246. The pillar 170 has a lower end 248 and an upper end 250. The upper strip tray 168 has a proximal wall 252, a distal wall 254, a first sidewall 256, a second sidewall 258, and a base 260. Each of these parts, except for the tension coils, can be injection molded out of a variety of plastics, and pigmented in a variety of colors. Features designed into the parts allow them to be snapped together without fasteners or adhesives. Suitable plastics include ABS, polycarbonate, acrylic, and styrene. In general, the parts can be made out of any injection moldable thermoplastic. Tension coils 178, 180, and 182 are used to retract the push plates 172, 174, and 176 as product is removed from the trays. The tension coils are typically made out of rolled steel approximately 0.010″ in thickness. Connecting mortises 184 are located along the sides of the trays, and mate with connecting tenons 186, illustrated in FIG. 13. When interlocked, the tenons and mortises join system trays with strip trays. As can be seen in the drawing, the display system 162 is modular in design, and can readily be assembled or disassembled. Modularity allows the retailer of self monitoring blood glucose equipment and supplies flexibility in displaying product.

FIG. 13 illustrates an additional perspective view of an embodiment of an apparatus for displaying self monitoring blood glucose equipment and supplies 162. In this view, the connecting tenons 186 can be seen.

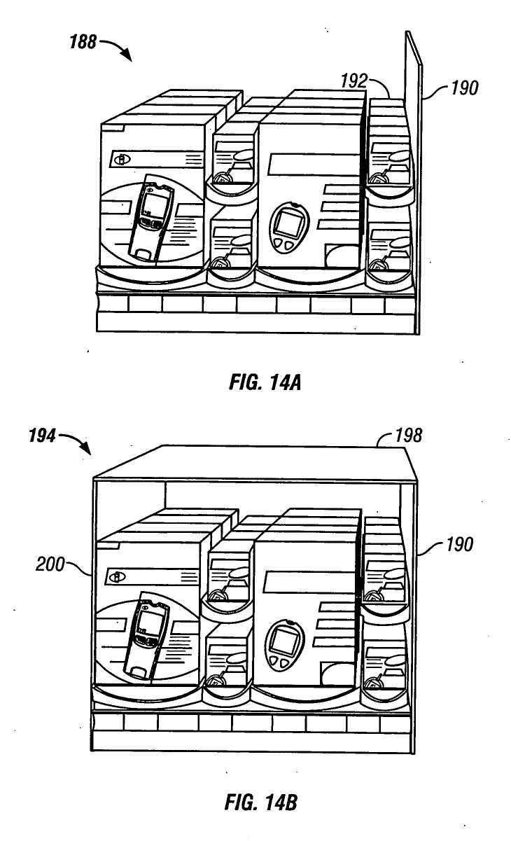

FIG. 14A illustrates an embodiment of an apparatus for displaying self monitoring blood glucose equipment and supplies 188 with a strip theft deterrent cover 190. When placed next to a row of strips 192, the strip theft deterrent cover 190 reduces access to the row of strips 192. This makes removal of a large quantity of test strips more conspicuous.

FIG. 14B illustrates an embodiment of an apparatus for displaying self monitoring blood glucose equipment and supplies 194 with a strip theft deterrent cover 190, a system theft deterrent cover 200, and an upper theft deterrent cover 198. The three covers 190, 200, and 198 prevent access from the sides of the apparatus. This makes removal of a large quantity of product conspicuous. Covers 19,0, 200, and 198 can be made from any rigid material including plastic, metal, or glass. The covers can be mounted directly to the trays with mechanical and/or adhesive fasteners, or can be free standing.

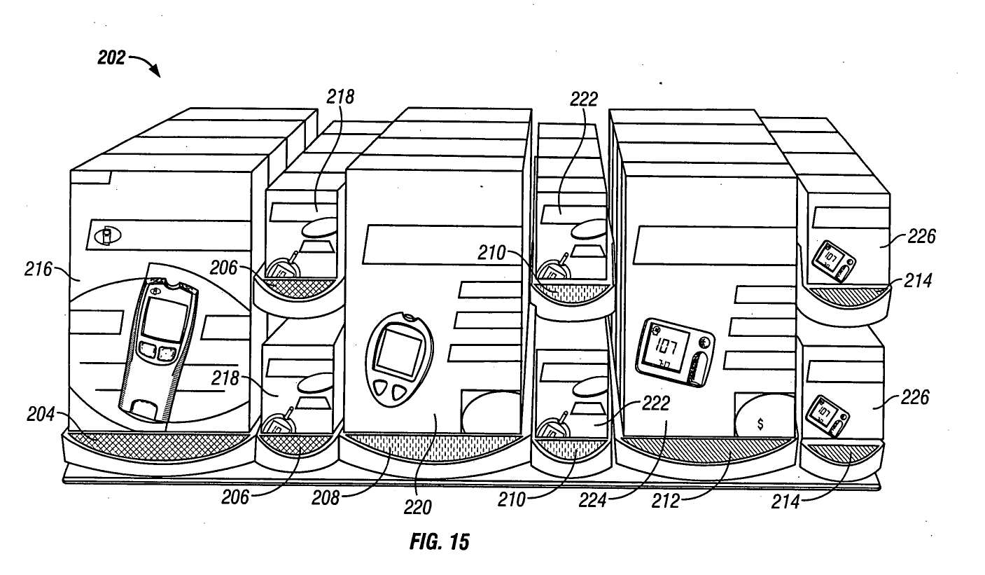

FIG. 15 illustrates an embodiment of an apparatus for displaying self monitoring blood glucose equipment and supplies 202 with coordinated signboards that assist in matching blood glucose monitoring test strips to the appropriate system. Signboards 204, 206, 208, 210, 212, and 214 assist in matching test strips 218, 222, and 226 to a particular system 216, 220, and 224. Signboards can include artwork and color schemes that assist the consumer in matching test strips to systems.

While the present invention has been described with reference to the specific embodiments thereof, it should be understood by those skilled in the art that various changes may be made and equivalents may be substituted without departing from the true spirit and scope of the invention. In addition, many modifications may be made to adapt a particular situation, material, composition of matter, process, process step or steps, to the objective, spirit and scope of the present invention. All such modifications are intended to be within the scope of the claims appended hereto.

That which is claimed is:

1. An apparatus for displaying self monitoring blood glucose systems and related strip supplies, the apparatus comprising:
a system tray configured for displaying self monitoring blood glucose systems in an accessible manner, the system tray having a system tray proximal wall, a system tray distal wall, a first system tray sidewall, a second system tray sidewall and a system tray base; and
a lower strip supply tray configured for displaying related strip supplies in an accessible manner, the lower strip supply tray having a lower strip supply tray proximal wall, a lower strip supply tray distal wall, a first lower strip supply tray sidewall, a second lower strip supply tray sidewall, and a lower strip supply tray base, the lower strip supply tray being connected at the first lower strip supply tray sidewall to the second system tray sidewall.

2. The apparatus of claim 1 further comprising:
a pillar with a lower end and an upper end, the pillar vertically connected at the lower end to the lower strip tray distal wall; and
an upper strip supply tray configured for displaying related strip supplies in an accessible manner, the upper strip supply tray being connected to the upper end of said pillar, wherein the upper strip supply tray has an upper strip supply tray proximal wall, an upper strip supply tray distal wall, an upper strip supply tray first sidewall, an upper strip supply tray second sidewall and an upper strip supply tray base.

3. The apparatus of claim 1 further comprising:
a system tray push plate, moveably connected to the system tray base;
a system tray tension coil, operatively positioned between the system tray base and the system tray push plate;
a lower strip tray push plate, moveably connected to the lower strip tray base; and
a lower strip tray tension coil, operatively positioned between the lower strip tray base and the lower strip tray push plate;
wherein the system tray push plate and system tray tension coil are configured to feed self monitoring blood glucose system systems towards the system tray proximal wall, and
wherein the lower tray push plate and lower strip tray tension coil are configured to feed related strip supplies towards the lower strip supply tray proximal wall.

4. The apparatus of claim 1 further comprising:
a system tray signboard, attached to the proximal wall of said system tray; and
a lower strip tray signboard, attached to the proximal wall of said lower strip tray.

5. The apparatus of claim 1 further comprising:
a first strip theft deterrent cover, vertically positioned adjacent to the lower strip tray second sidewall, the strip deterrent cover configured to limit access, from a side of the apparatus, to related strip supplies displayed in apparatus.

6. The apparatus of claim 1 further comprising:
a second trip theft deterrent cover, vertically positioned adjacent to the first system tray sidewall, the second strip deterrent cover configured to limit access, from a side of the apparatus, to self monitoring blood glucose systems displayed in apparatus; and
an upper theft deterrent cover positioned to limit access, from a top side of the apparatus, to self monitoring blood glucose systems and related supplies displayed in the apparatus.
